(19) United States
(12) Patent Application Publication
(10) Pub. No.: US 2011/0029441 A1
(43) Pub. Date: Feb. 3, 2011

(54) METHOD TO GENERATE WORKFLOW TASKS DIRECTLY FROM FLOWCHARTS FOR PROCESSING EVENTS IN EVENT-DRIVEN JUDICIAL CASE MANAGEMENT SYSTEMS WITH WORKFLOW CONTROL

(76) Inventors: Pronob K. GUPTA, Iselin, NJ (US); Mark C. Gruensfelder, Iselin, NJ (US); Alex Chernyak, Iselin, NJ (US)

Correspondence Address: PORZIO, BROMBERG & NEWMAN, P.C., Suite 201, 29 Thanet Road, Princeton, NJ, 08540, US

(21) Appl. No.: 12/721,630

(22) Filed: Mar. 11, 2010

Related U.S. Application Data
(60) Provisional application No. 61/229,894, filed on Jul. 30, 2009.

(51) Int. Cl. G06Q 10/00; G06F 17/00; G06N 7/00

(52) U.S. Cl. 705/301; 707/608; 706/57

(57) ABSTRACT

The present invention relates to a method and system for workflow management to automate the creation of event-task entries directly from flowcharts. The method and system of the present invention includes an entry described as MFIN. A MFIN is defined as a flowchart of a process that can be triggered by one or more events. When flowcharts are finalized, they are “published”, in which the system automatically parses the flowcharts, and populates a “published flowcharts table” with information regarding the tasks required to process each event, together with logical decisions, and timers (for tickler notifications) to be started. Instances of the MFINs are executed upon the occurrence of one or more events by looking up the entry in the “published flowcharts table” for that event, and triggering the specified tasks for the specified users.

### CROSS REFERENCE TO RELATED APPLICATION

This application claims the benefit of U.S. Provisional Patent Application No. 61/229,894, filed Jul. 30, 2009, the entirety of which is hereby incorporated by reference into this application.

### BACKGROUND OF THE INVENTION

1. Field of the invention

This invention relates to case management systems (CMSs), in particular for the Judiciary, and the automatic generation of workflow tasks based on flowcharts defined for processing events with event-driven workflow control.

2. Description of the related art

Conventional case management systems (CMSs) have been accurate batch-oriented record keeping systems, reporting accurately on past information, enabling management to retrospectively answer questions such as “How did we do?”

With the relatively recent technology advances, case management systems (CMSs) are now beginning to approach real-time systems, with emphasis on helping management answer questions such as (1) “What do I need to do today?”; (2) “What is going wrong?”; and (3) “What corrective action do I need to take today?”

Efforts are being made to developing case management systems (CMSs) for the Judiciary are aimed at helping management control their processes and operations; highlighting exceptions that need management attention; and providing advance notifications of developing situations which can be pre-empted by prompt corrective action.

The National Center for State Courts (NCSC) has recommended event-driven case management systems (CMSs) with workflow control, in its functional requirements for case management systems (CMSs). Accordingly, case management systems (CMSs) for the Judiciary are evolving from the legacy “record-keeping” and “Management Information Systems” to the “next generation” paradigm of “Management and Control Systems”. RFPs being issued by courts are beginning to require these “Next Generation” features.

“Next Generation” case management systems (CMSs) take advantage of the fact that court processes are event-driven. As each event occurs in the case-flow (for example, a case is initiated, a hearing is held, and so forth), the court's policies and processes mandate the activities that need to be performed to service the event. When these activities are completed, the case then waits for the next event to occur.

The “next generation” case management systems (CMSs), therefore, effectively need to maintain an “Events-Tasks” table in its database, with an entry for each and every unique event that can occur in the case-flow, mapped to the corresponding workflow tasks that need to be triggered (possibly with assignee and due date) when that event occurs.

The number of possible events that could occur during the processing of any one type of case is large for ranging from case initiation through disposition, and in some types of cases, post-disposition. With courts generally handling different types of cases, the number of events in the table is multiplied. One such set of entries for each case type. The factor results in an undesirable very large size of the “Event-Tasks”.

Court processes and policies typically need to cover the various situations that could arise in the flow of a case including normal flow and exceptions and reflect decision logic in court processes. The Events-Tasks table could have decision-making logic incorporated, but nevertheless the tasks for each of these exception situations would also necessarily have entries in the event-tasks table. This, again, increases the number of events that need to be recognized, and tasks specified, in the event-tasks table.

Manual implementation of the event-tasks table has to include the following activities: document the court's processes for each case-type. This could be a written document, or a flowchart; include the exception situations that could occur, and specify processing tasks; include conditional processing logic, with the tasks specified for leg of decision blocks; and define events required for each case type, including events for each leg of each decision block in the flowcharts. The latter is necessary to be able to have an entry for each leg in the events-task table. Some implementations may incorporate decision-logic handling capabilities in the events-tasks table. Accordingly, the tasks to process each leg of each decision block have to be entered.

This manual approach has the drawback of being cumbersome, tedious, and error-prone since the implementer has to interpret the court policies and processes (text or flowchart) and convert them to events and tasks in the “events-tasks” table.

It is also difficult for debugging errors that do occur in such an environment. With complex flowcharts, and the large number of entries in the events-tasks table, locating of relevant entries or the relevant point in the flowchart can be very difficult.

Court policies can change. When this occurs, making a change in the flowchart and identifying the entries in the events-tasks table that need to change, and making the changes, can be a complex undertaking Since they are two different activities, there is a strong possibility that the case management system (CMS) events-tasks table does not accurately reflect the latest version of the process documentation (text or flowchart) and there can be possible loss of synchronization between flowchart and events-tasks table.

It is desirable to provide a case management system (CMS) as a management tool that automatically ensures that the court's policies and processes are being followed in the processing of cases. Workflow tasks required to process each event in the case-flow are generated automatically. The exception situations that need attention and are highlighted and possibly require pre-emptive corrective action. Court staff should not have to scan each and every case on an on-going basis to identify these situations, facilitate the establishment of time standards for case processing activities, monitor the adherence to time standards for these activities. Exception situations should include, at a minimum, workflow task not being completed; court process not being followed; workflow task not being completed within time standard; and deadlines not being met, such as, submission of documents, and the like. Exception situations should also provide an “agile” platform that has the flexibility to be configured to suit requirements of individual regions/offices/users.

### SUMMARY OF THE INVENTION

The present invention relates to a method and system to automate the creation of event-task entries directly from flowcharts. The present invention has the advantages of simplifying the event-task creation process, eliminating errors, simplifying debugging, and maintaining synchronization between the process documentation (flowchart) and the case management system (CMS) of the present invention.

The method and system of the present invention includes an entry described as MFIN. The present invention defines MFIN as a flowchart of a process that can be triggered by one or more events. Within the MFIN, one or more events can be set, but none of these can be processed within the same MFIN. An event can trigger the start of one or more MFINs. However, MFINs do not have the capability to pause and wait for some external event to continue onto subsequent tasks. Rather, the external event and the subsequent tasks would be combined into a separate MFIN. The MFIN allows the case management system (CMS) to greatly simplify the debugging process needed, and to determine the entry point in flowcharts for each event that needs to be processed.

In the method, users, such as Court Business Analysts, prepare flowcharts in the case management system (CMS) of the present invention of a court's policies and processes for each case type, using a flowchart editor module. When flowcharts are finalized, they are “published”, in which the case management system (CMS) automatically parses the flowcharts, and populates a “published flowcharts table” with information regarding the tasks required to process each event, together with logical decisions, and timers (for tickler notifications) to be started. When a case is active, and the case management system (CMS) recognizes that an event for a case has occurred, it looks up the entry in the “published flowcharts table” for that event, and triggers the specified tasks for the specified users. It also starts the specified timers, if any. As the case progresses, and the user enters case data, the case management system (CMS) analyzes the updated case data per business rules to automatically detect the occurrence of the next event in the case-flow. When the case management system (CMS) detects that a new event has occurred, the cycle repeats to process the new event.

The present invention drives case management systems workflow directly from policies and processes expressed in flowcharts. (As opposed to driving these systems from unwieldy spreadsheets.) and provides a means for converting flowcharts to workflow processing tables. The flowcharts could apply to Case Management Systems or other general business systems. The present invention provides a MFIN concept which has the advantage of being more practical for debugging and maintainability.

The present invention provides a concept of using specialized icons to indicate different flowchart symbols, specific to actions needed for Case Management systems.

The present invention provides the ability to associate flowcharts with entities in the organization at the same hierarchical level, for example, criminal cases are processed differently in different counties for the same circuit court. Each county would have its own flowchart with the same name. The county the case belongs to determines which version of the flowchart is utilized at run-time.

The present invention provides the ability to select the flowchart currently in effect from a set of flowcharts of different versions with specified effective dates.

The invention will be more fully described by reference to the following drawings.

### BRIEF DESCRIPTION OF THE DRAWINGS

FIG. 1 is a schematic diagram of case management system (CMS) in accordance with the teachings of the present invention.

FIG. 2 is a schematic diagram of creation of a MFIN.

FIG. 3 is a flow diagram of steps for publishing a validated MFIN.

FIG. 4 is a schematic diagram for a user event setting.

FIG. 5 is a schematic diagram for an attribute event setting.

FIG. 6 is a schematic diagram for a timer event setting.

FIG. 7 is a schematic diagram for execution of a MFIN.

FIG. 8 is a schematic diagram of a screen for a system upon login with expanded menu and tasks on the queue.

FIG. 9 is a schematic diagram of a screen for a flowchart after it is first retrieved for editing.

FIG. 10 is a schematic diagram of a screen for a flowchart showing start properties.

FIG. 11 is a schematic diagram of a screen for a flowchart showing decision block properties.

FIG. 12 is a schematic diagram of a screen for a flowchart editor after user selects the “Publish” menu item.

FIG. 13 is a schematic diagram of a screen for “My Tasks” for the case I'm working on.

FIG. 14 is a schematic diagram of a screen for processes triggered for a particular case.

FIG. 15 is a schematic diagram of a screen for a display flowchart of one of the processes. Note that the middle block is dimmed, indicating that this is the current step in the particular process.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

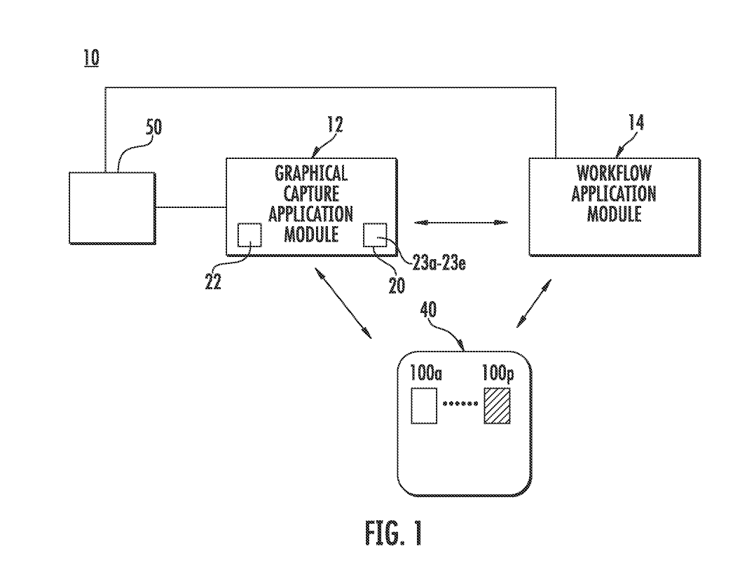

FIG. 1 is a schematic diagram of workflow management system 10 in accordance with the teachings of the present invention. In one embodiment workflow management system 10 can be a case management system (CMS). Graphical capture application module 12 allows users to create, edit, save, validate, and publish flowchart-based MFINs 20. Workflow application module 14 creates, processes, and tracks published MFINs 20 instantiated as a result of user interaction. User interface 50 accesses graphical capture module 12. It will be appreciated that graphical capture application module 12 and workflow application module 14 are software applications which can be performed by a computer.

Flowcharting refers to the activities analysts perform in capturing a MFIN. Graphical capture application module 12 is used for flowcharting. Graphical capture application module 12 has the capability of translating captured symbols into a well-defined structured text data format, such as XML. Other conventional streamlined text data format languages can be used in accordance with the teachings of the present invention.

The following MFIN information can be used to create each MFIN 20:

1. MFINs Name 23a

2. Description 23b

3. Case Type 23c utilizing the MFINs

4. Applicable hierarchy 23d level the MFIN applies to

5. Default Assignee 23e for each task, used if a task doesn't specify an assignee

6. Event(s) 23f which trigger the MFINs

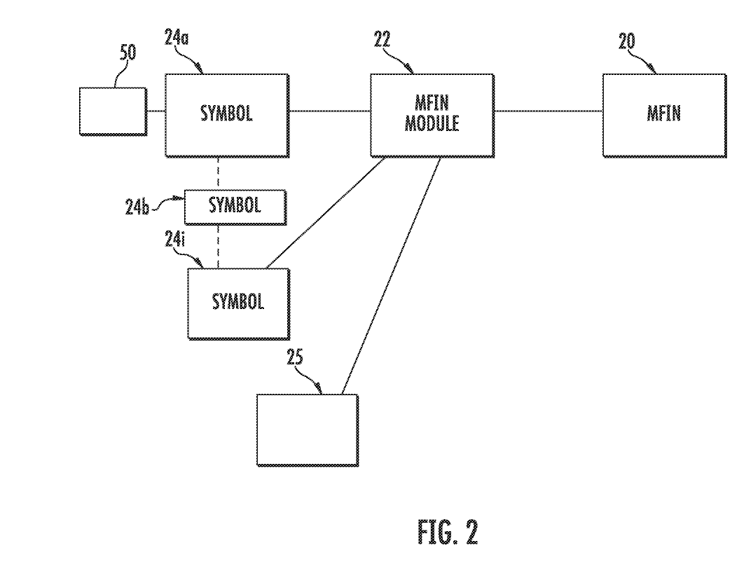

MFIN 20 is generated using MFIN module 22 of graphical capture application module 12 through the use of a library of symbols, as shown in FIG. 2. The library of symbols described below has been chosen based on the characteristics of MFINs used in case management. Each of the symbols relate to a functional element having associated properties which can have interconnections between the functional elements. Example symbols, and the information to be gathered about each, are as follows:

MFIN Start symbol 24a serves as the entry point to MFIN 20. The MFIN's information is gathered with this symbol.

Task symbol 24b denotes an activity assigned to a person with a due date. The information gathered is: Task Name, description, duration, and default assignee.

Decision symbol 24c provides a means for MFIN 20 flow to branch in one direction or another. The information gathered is Name and a true/false expression composed of operations of case table attributes.

Wait symbol 24d provides a means for MFIN 20 flow to pause for a specified duration. The information gathered is the wait symbol category and the duration of the wait.

Tickler symbol 24e provides a means to set and control a timer. If the timer is allowed to expire, an alert could be generated. The information gathered is the tickler category, Tickler Duration, an Event to set if the Tickler expires, and an Event that, if set, terminates the tickler without setting the expiration event. MFIN 20 flow continues through a tickler without pause.

Set event symbol 24f provides a means for an MFIN 20 to set an event that could trigger a different MFIN 20. The information gathered is the name of the symbol and the name of the event to be set.

Action symbol 24g provides a means for specific system actions to be executed. In its present embodiment, implemented actions include Setting the Case Status, Setting the Register of Actions, and controlling Ticklers and Wait symbols. The information gathered is the name of action symbol 24g and the indicated action.

Comment symbol 24h provides a means for the analyst to document the purpose for certain aspects of the MFIN 20. The information gathered is the name of the comment symbol and the comment itself.

End symbol 24i provides a means for MFIN's 20 flow to stop. The information gathered is the name of the end symbol.

Symbol connector 25 provides a means to establish flow between pairs of symbols. The information gathered is optional annotation text.

MFINs 20 are saved to database 40 accessed by graphical capture application module 12, as shown in FIG. 1. Each MFIN 20 is saved as a single XML file containing all the symbol, connector, and gathered information. This allows users to retrieve and edit their prior work. It will be appreciated that other conventional languages can be used for saving MFINs.

MFINs 20 are validated by graphical capture application module 12 prior to being published. Validation examines the XML file and identifies situations that would cause MFIN 20 to operate incorrectly. For example, errors are flagged for unconnected links, symbols missing input or output links or too many links, invalid expressions in decision symbols, and others.

Validated MFINs 20 are published. Publishing extracts symbol and flow information from MFIN's 20 XML file and places the information into appropriate tables in database 40.

Database 40 is accessed by graphical capture application module 12 and workflow application module 14. Database 40 stores lookup and configuration information used by graphical capture application module 12; stores MFIN's 20 information extracted when MFIN 20 is published, stores MFIN 20 and symbol instance information for caseflow instances, and stores case status and register of actions tables.

Workflow management system 10 can be a web-based computer application. In one embodiment workflow management system 10 is utilized for judicial case management purposes. In a preferred embodiment workflow management system 10 is a web-based computer application which can be utilized for judicial case management. MFINs 20 can be related to a predetermined workflow type. In one embodiment, MFINs 20 can be directed to a predetermined judicial case type. MFINs 20 can be related to the same hierarchical level. For example, MFINs 20 can be related to a case type at a particular judicial level, for example a circuit court level.

Tables 100a-100p lists attributes that are relevant to the invention and are used in graphical capture application module 12 and workflow application module 14 are described below. Tables 100a-100p are stored in database 40.

Lookup and Configuration Information

Events table 100a lists allowable events by name and description and is used by MFIN Start symbol 24a.

Screen Actions to Events table 100b defines a mapping of user actions on screens 50, as shown in FIG. 1 to events. Each record contains screen, button on the screen, qualifying expression, and event to set if the user presses the given button and the qualifying expression is evaluated to true.

Tickler Types table 100c defines the tickler types that are in case management system (CMS) 10. Each record contains a tickler type name and description.

Tickler Subscriptions table 100d defines how each user is impacted by the status of ticklers of a given type. Each record of table 100d contains a tickler type, the given user, the text of any notification message generated as a result of the tickler, and when such notifications should occur.

Case Types table 100e lists allowable Case Types by name and description. Used by MFIN Start symbol 24a.

Case Status table 100f lists allowable Case Statuses by name and description. Used by MFIN Action symbol 24g.

Extracted MFIN Information

MFINs Table 100g stores a record for each MFIN 20 published by the graphical capture application module 12. Each record contains the name and description of MFIN 20, versioning and effective date information, applicable hierarchy level, the starting MFIN Symbol record, case type MFIN applies to, and the default assignee.

MFIN Symbols table 100h stores a record for each symbol 24a-24i for each MFIN 20. Each record contains the associated MFIN 20 and symbol 24a-24i, along with the symbol type (e.g. “start”, “task”, “decision”, and the like), the next MFIN Symbols record in the flow, the next MFIN Symbols record in the flow to be taken if the decision expression is evaluated to “false” (applicable only to decision symbols), default assignee for the symbol (if applicable), duration (if applicable), tickler type along with expiration and terminating events (if applicable), action code and case status (if applicable), and decision symbol 24c expression (if applicable).

Events to MFINs table 100i stores which events trigger which MFINs 20. Each record contains an Event and an MFIN 20.

Caseflow Instance Information

Event Instances table 100j stores a record for each event that occurs for each case. Tabulates the number of processes initiated and ticklers terminated by this event instance.

MFIN Instances table 100k stores a record for each instantiated MFIN 20 for each case. Each record contains the associated MFIN 20 and case, the processing status of the instance (active or done), who initiated this MFIN instance and via what event, initiation and (if applicable) finish date of this MFIN instance, and the actual assignee.

MFIN Symbol Instances table 100l stores a record for each symbol processed for an MFIN Instance. Each record contains the MFIN Instance, the MFIN Symbol being processed, the MFIN Symbol status (Pending, Done), the actual assignee, actual start date, planned and actual finish dates, actual duration, and the results of decision symbol expression (if applicable).

Tickler Instances table 100m stores a record for each instantiated tickler. Each record contains the Tickler Type, the MFIN Instance, the MFIN Symbol Instance, and the tickler status (set, suspended, resumed, reset).

Notification Instances table 100n stores a record for each notification generated as a result of tickler actions. Each record contains the applicable Tickler Subscription record, the tickler instance itself, the status of the notification (pending, displayed, or acknowledged), and notification dates.

Case Status and Register of Actions Information

Register of Actions table 100o stores a history of events on a per-case basis as well as user-entered approvals and notes. A new record is added each time an MFIN is triggered by an event.

Case Status table 100p stores the current status or state of each case, based on the execution of MFIN Action Symbols 24g.

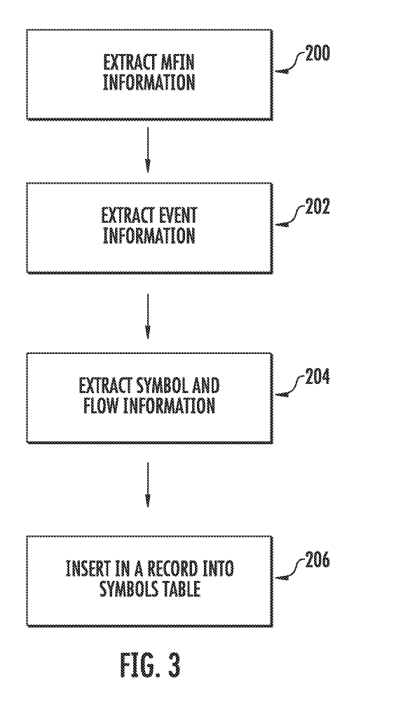

Publishing a validated MFIN 20 results in the population of the workflow application module's 14 database tables 100g, 100h, and 100i. The publishing function extracts information from the MFIN's XML file and places this information into the appropriate database tables. More specifically, the following steps are executed, as shown in FIG. 3:

In block 200, Extract MFIN information 23a-23e from the information gathered about the MFIN itself from the XML file, and insert this information into MFIN's table 100g. Set the “date effective” to a date specified by the user. If this same MFIN 20 had been previously published, locate its record and set its “date no longer effective” to the same date specified by the user.

In block 202, Extract MFIN event information 23f from the information gathered about the MFIN itself from the XML file. Insert a record for each triggering event into the “Events to MFINs” table 100i containing the event and a reference to the MFIN record created in block 200.

In block 204, Extract the Symbol and Flow information from the XML file. Exclude the Comment symbol.

In block 206, for each Symbol, insert a record into the MFIN Symbols table 100h. Include a reference to the MFIN created in block 200, the symbol type, the next MFIN Symbol in the flow, and the other data based on the symbol type.

The workflow application module 14 instantiates and processes MFINs 20 based on the setting of events as described below.

Setting Events

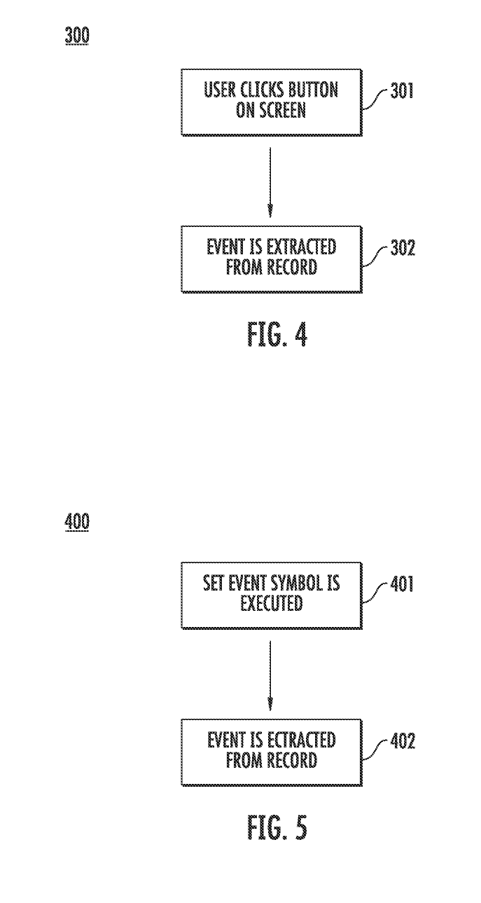

In the present invention, there are three ways which events can be set, shown in FIGS. 4-6. In a first embodiment 300, shown in FIG. 4, in block 301, the user clicks a button on a screen for which there is a record in the Screen Actions to Events table 100b, and the qualifying expression for that record evaluates to “true”. In block 302, the event that is set is extracted from this record.

In a second embodiment 400 shown in FIG. 5, workflow application module 14 executes Set Event symbol for an already-instantiated MFIN 20 in block 401. The event is extracted from the MFINs Symbols table 100h for the MFIN corresponding to the MFIN instance and the symbol corresponding to the symbol instance, in block 402.

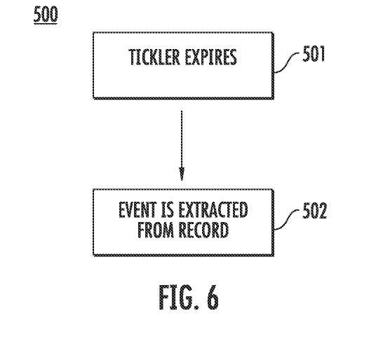

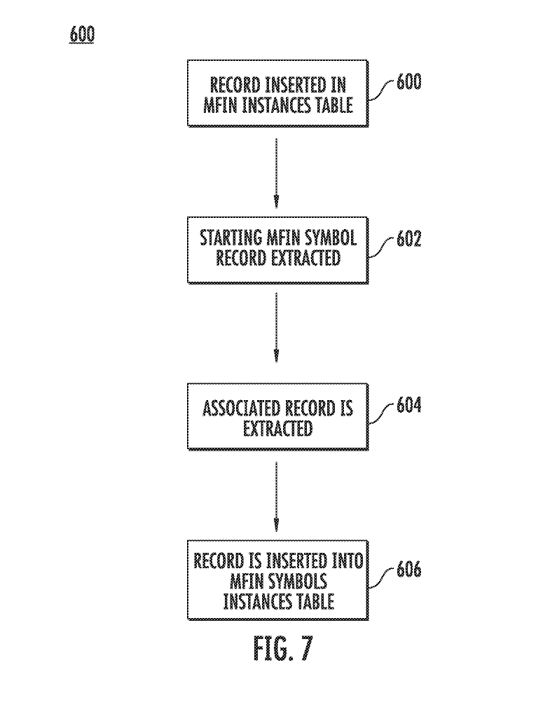

In a third embodiment 500, shown in FIG. 6, a Tickler Instance, corresponding to an already-instantiated MFIN 20, expires, as processed by workflow application module 14, in block 501. The event, if any, is extracted by the MFIN Symbols table 100h table for the MFIN corresponding to the MFIN instance corresponding to the Tickler Instance, and the symbol corresponding to the symbol instance corresponding to the Tickler Instance, in block 502.

Whenever an event is set, a record is inserted into the Event Instances table 100j. For event setting embodiment 300, the case attribute of this table is populated with the case the user is working with. For embodiment 400 and embodiment 500, the case attribute is extracted from the MFIN Instances table 100k for the already-instantiated MFIN.

When an event is set, workflow application module 14 obtains MFINs 20 to instantiate, if any, from the Events to MFINs table 100i corresponding to the set event. For each such MFIN, the following steps are executed, as shown in FIG. 7.

In block 600, a record is inserted into the MFIN Instances table 100k for the given MFIN 20. The case attribute is set as described above. The processing status is set to “Active”. The “who initiated” attribute is set to the user for event setting embodiment 300 and to the assignee attribute of the Set Event embodiment 400 event setting or Timer instance embodiment 500 event setting. The initiating event is set to the event which triggered this MFIN. The initiation date is set to the current date. The actual assignee is set to the default assignee in MFIN's table 100g.

In block 602, The “Starting MFIN Symbol” record is extracted from MFIN's table 100g.

In block 604, the record associated with this “Starting MFIN Symbol” record is extracted from the “MFIN Symbols” table 100h.

In block 606, a record is inserted into MFIN Symbol Instances table 100l referring to this extracted MFIN's Symbols record. This record also refers to MFIN Instances 100k record of block 600. Its “actual start date” is set to the current date, and the other attributes depend on the specific symbol type.

Further actions are a function of symbol type and are described below.

Symbol Execution

Execution of the MFIN Instance proceeds based on the type of symbol.

Start

MFIN Start symbol 24a is just a placeholder as the entry point into MFIN 20. No action is taken other than to move to the next symbol. The “Next Symbols Record” is extracted from MFIN Symbols table 100h for the Symbol associated with this Symbols Instance. Execution then proceeds to block 606.

Task

For task symbol 24b, the record inserted into MFIN Symbol Instances table 100l also includes “symbol status” set to “pending”, the “actual assignee” set to the associated MFIN Instances “actual assignee”, and the “planned finished date” set to the “actual start date” plus the “duration” from MFIN Symbols table 100h for MFIN 20 and symbol associated with this symbol instance. Execution stops, awaiting the user to complete this task.

Decision

For decision symbol 24c, the record inserted into the MFIN Symbol Instances table 100l also includes the results of the decision symbol expression. The decision expression is a mathematically calculated Boolean expression containing references to the value of an attribute stored in a specified case-related table in workflow application module 14. The value of the attribute is found by selecting the record corresponding to the case in the specified case-related table. The value of each such reference is determined and the decision expression is evaluated, with the result being either “true” or “false”. The result determines which of the two “Next Symbols Record” attributes to be is extracted from the MFIN Symbols table 100h for the Symbol associated with this Symbols Instance. Execution then proceeds with block 606.

Wait

For wait symbol 24d, the record inserted into MFIN Symbol Instances table 100l also includes setting the status to “pending” and setting the “planned finish date” to the “actual start date” plus the “duration” from MFIN Symbols table 100h for MFIN 20 and symbol associated with this symbol instance. Execution stops until the “planned finish date” is reached or the wait terminated as a result of an action.

Tickler

For tickler symbol 24e, the record inserted into the MFIN Symbol Instances table 100l also includes setting the status to “pending” and setting the “planned finish date” to the “actual start date” plus the “duration” from MFIN Symbols table 100 for MFIN 20 and symbol associated with this symbol instance. In addition, a record is inserted into the Tickler Instances table 100m with the Tickler Type from MFIN Symbols table 100h, references to the MFIN Instance and this symbol instance, and a tickler status of “set”. The “Next Symbols Record” is extracted from the MFIN Symbols table 100h for the Symbol associated with this Symbols Instance. Execution then proceeds with block 606.

Set Event

For set event symbol 24f, the record inserted into the MFIN Symbol Instances table 100l does not include any additional data. Event Processing of blocks 600-606 is recursively called from this point. When the execution associated with this recursive call is complete, the “Next Symbols Record” is extracted from the MFIN Symbols table 100h for the Symbol associated with this Symbols Instance. Execution then proceeds with block 606.

Action

For action symbol 24g, the record inserted into the MFIN Symbol Instances table 100l does not include any additional data. What happens next is dependent on the specific action, as follows:

For the “Setting the Case Status” action, a record is inserted or updated in the “Case Status” table 100p for the case associated with the MFIN Instance, with the case status found in the associated MFIN Symbols record.

For the “Setting the Register of Actions” action, a new record is inserted into the Register of Actions table 100o containing the event that triggered this MFIN Instance (from MFIN Instances table 100k for this MFIN instance).

For the controlling of Wait Symbols 24d or Tickler Symbols 24e, the action can change the remaining wait or tickler time amount by changing the Planned Finish Date by the specified of the Wait timer of the specified category. The action can also change the tickler status in the Tickler Instances table 100m.

When the action is complete, the “Next Symbols Record” is extracted from the MFIN Symbols table 100h for the Symbol associated with this Symbols Instance. Execution then proceeds with block 606.

End

End symbol 24h causes execution to stop. The status of the associated MFIN Instance is set to “done”.

Processing Pending Wait Symbols

On a periodic basis, workflow application module 14 selects all pending MFIN Symbol Instances which are associated with “wait” symbols from the MFIN Symbol table 100h. For each such “wait” symbol whose planned finish date is on or before the current date, the following steps occur:

1. The status of the associated MFIN Symbol Instances record is set to “Done”.

2. The actual finish is set to the current date.

3. The “Next Symbols Record” is extracted from the MFIN Symbols table 100h for the Symbol associated with this Symbols Instance. Execution then proceeds with block 606.

Processing Pending Tickler Symbols

On a periodic basis, workflow application module 14 processes each record in the

Tickler Instances table 100m whose status is NOT “suspended”. For each such record, the following steps occur:

1. Extract the MFIN Symbols Instances record corresponding to the tickler instance.

2. Extract the Tickler Subscription corresponding to the Tickler Type and Tickler Assignee.

3. Based on the planned finish date, subscription parameters, and current time, determine if a notification should be generated or it the tickler has expired.

4. If a notification should be generated, insert a record in the Notification Instances table referencing the Tickler Subscription record and with a status of “pending”.

5. If the tickler has expired, set the appropriate status in both the “Tickler Instances” table as well as in the MFIN Symbol Instances table 100l. If there is an expiration event in the MFIN Symbols table 100h associated with this tickler instance, then workflow application module 14 obtains MFINs 20 to instantiate, if any, from the Events to MFINs table 100i corresponding to the expiration event. For each such MFIN, execution proceeds from block 600.

Workflow Queue

Whenever a user requests his/her Workflow Queue screen, display all pending tasks in MFIN Symbol Instances table 100l assigned to that user. If the user “completes” a particular task, the corresponding record in MFIN Symbol Instances table 100l is updated to indicate “complete”. Then the “Next Symbols Record” is extracted from the MFIN Symbols table 100h for the Symbol associated with this Symbols Instance. Execution then proceeds with block 606.

Notification Processing

Whenever a user logs in, as well as periodically, workflow application module 14 identifies any unacknowledged notifications associated with that user from Notification Instances table 100n with help from Tickler Subscriptions table 100d. If there are one or more such notifications, a notification indicator will appear on the user's display. The user can display such notifications and acknowledge them. If a notification is acknowledged, the notification status is updated in the Notification Instances table 100n.

Indicating Current Status and State

The embodiment of this invention provides users with various caseflow processing information so that users can determine the Workflow Application's location for a given case.

Currently Active MFIN Instances

Workflow application module 14 can display the currently active MFIN Instances for a case by selecting records from MFIN Instances table 100k associated with the case whose status is active.

Display Flowchart and Current Step an Active MFIN Instance

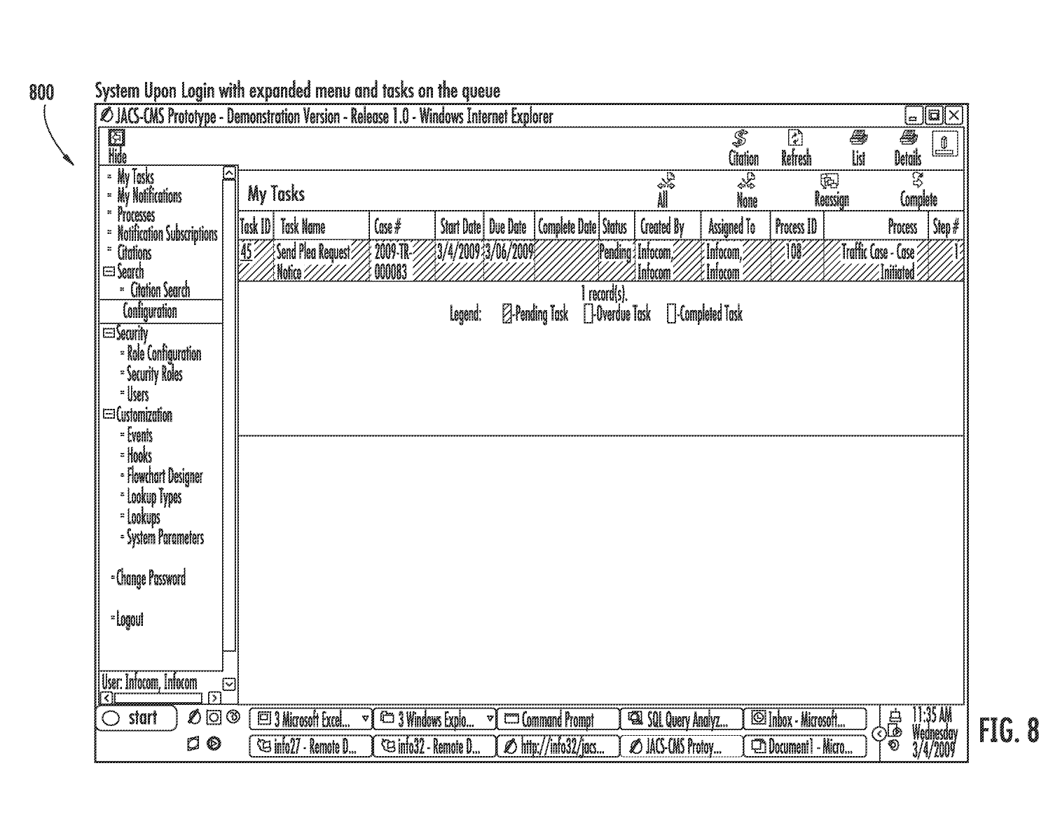

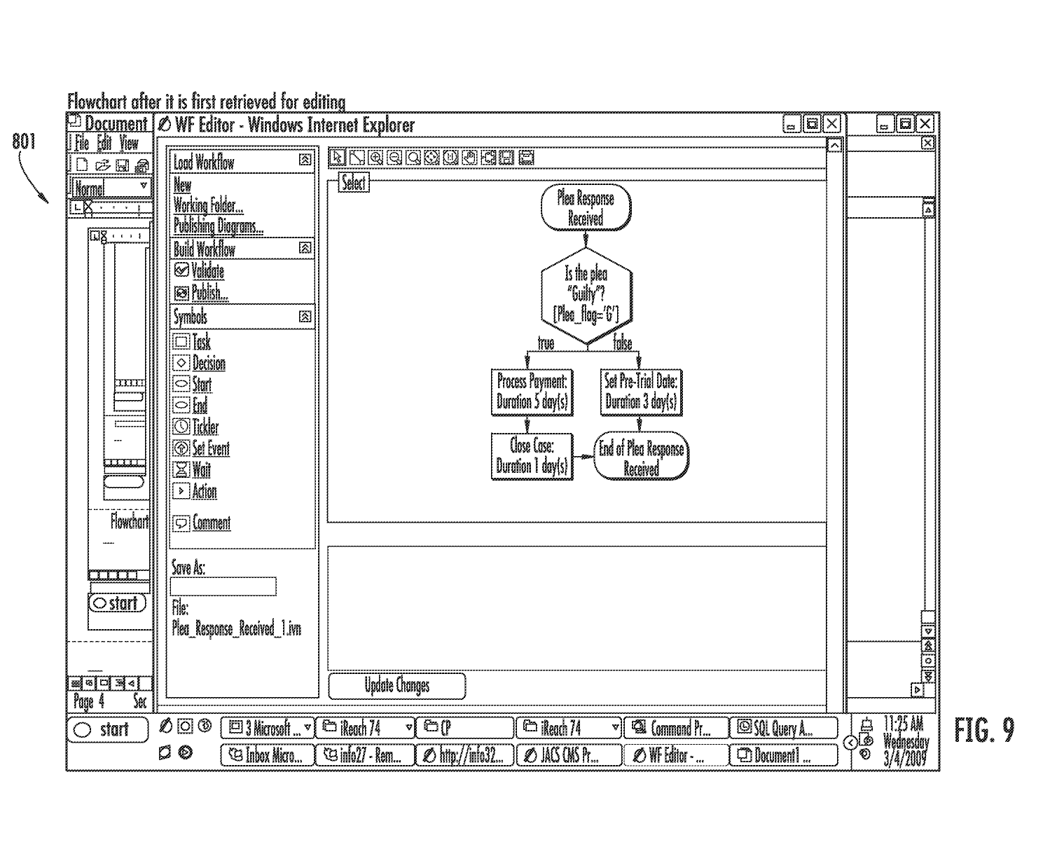

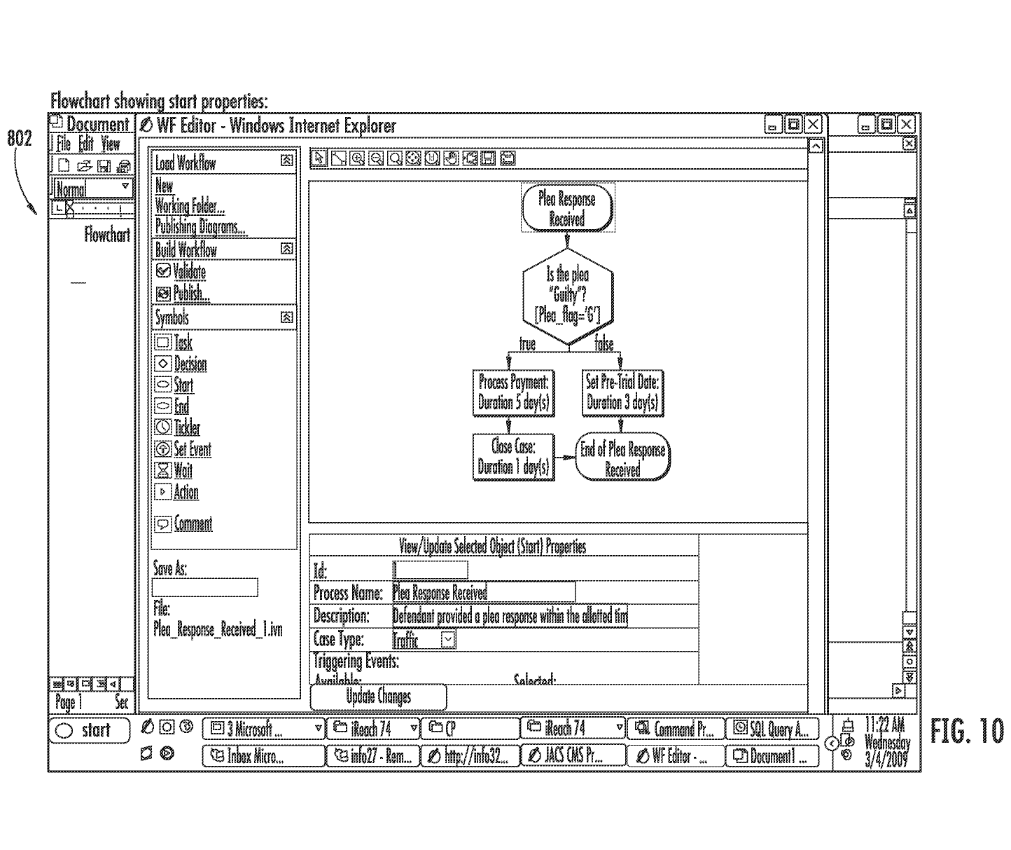

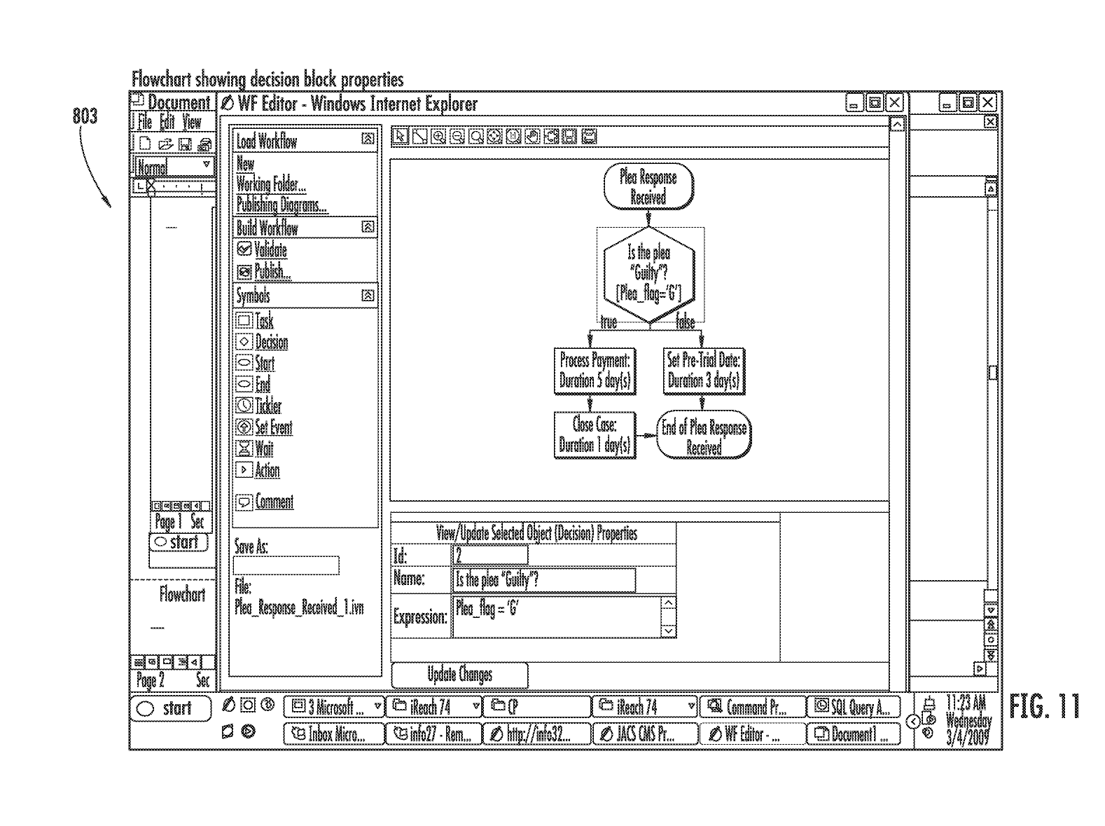

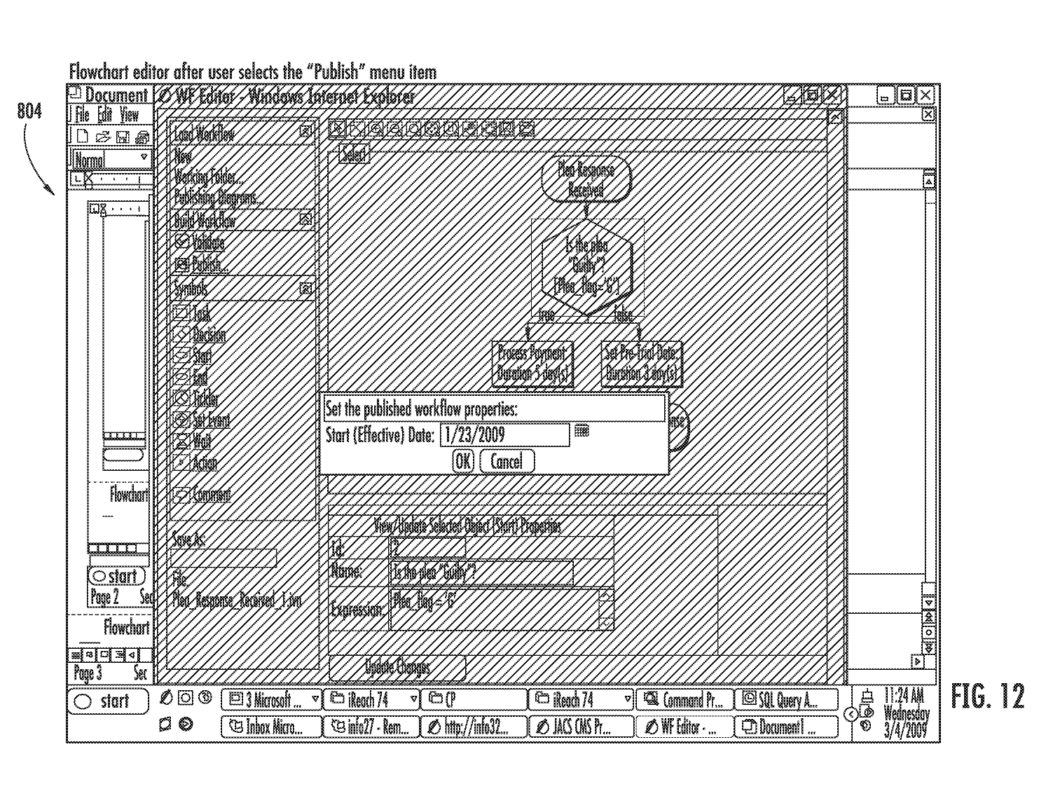

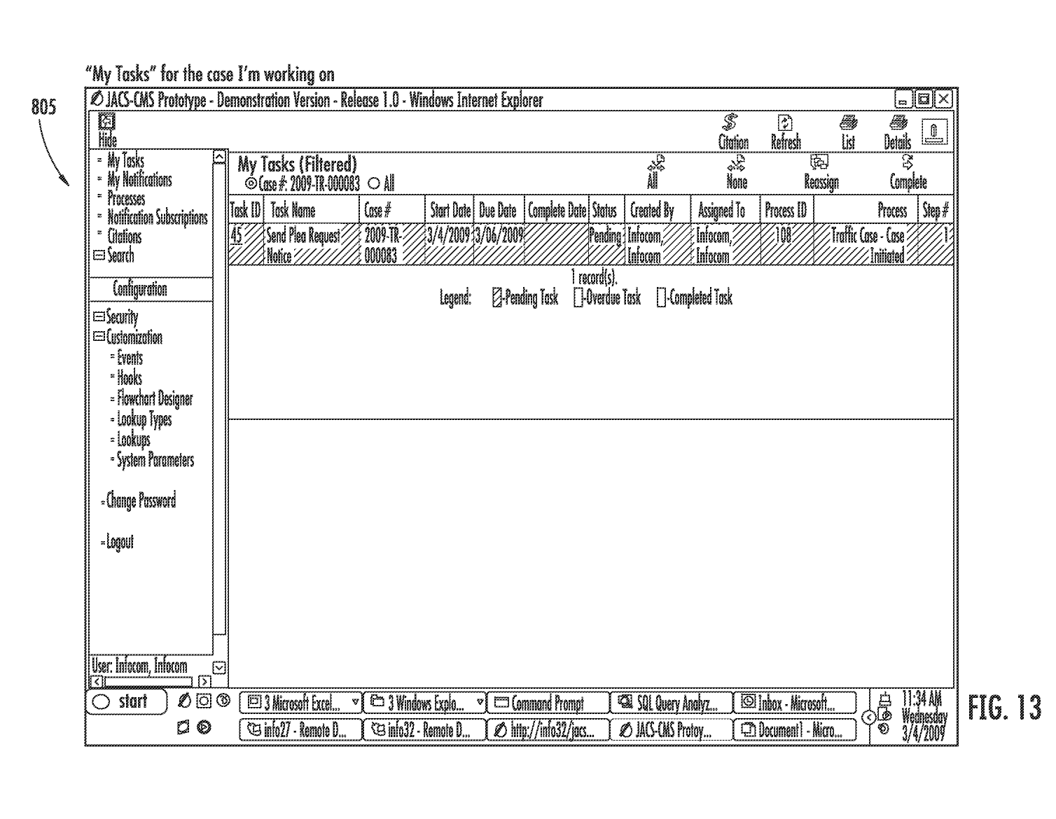

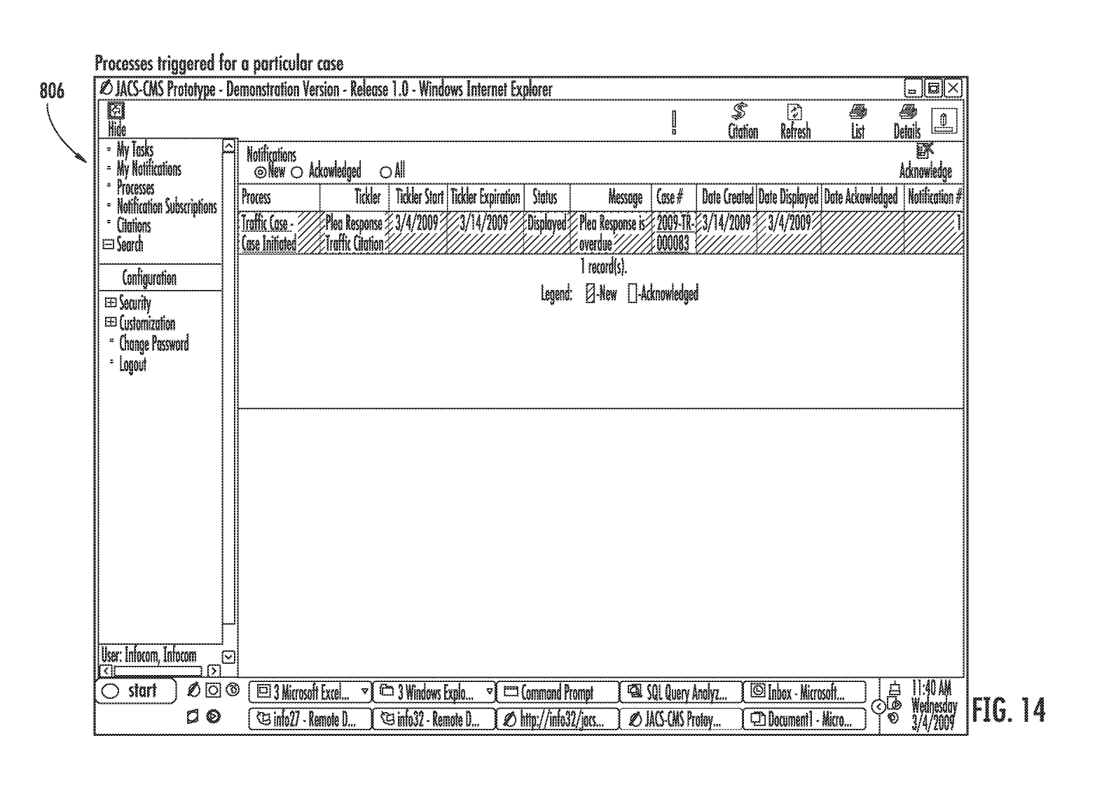

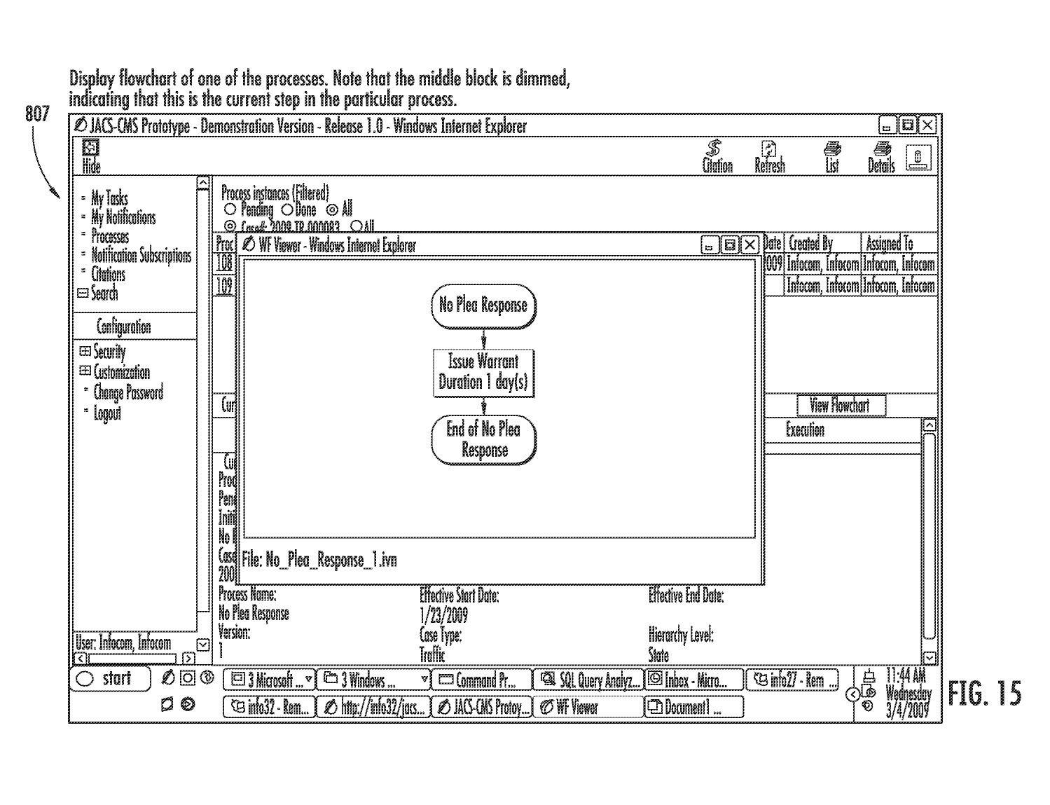

Graphical capture application module 12 can display the MFIN flowchart associated with an XML file and shade a given symbol as shown in screens 800-807 of FIGS. 8-15 which are displayed on user interface 50. Thus, if a user selects an active MFIN Instance, the name of the MFIN is determined from the associated MFIN table 100g. The currently active Symbol Instance is determined by locating the active Symbol Instance in MFIN Symbol Instances table 100l for the MFIN Instance. Once the Symbol Instance is identified, the Symbol Name is extracted from the associated MFIN Symbols table 100h. The MFIN and Symbol names are then provided to graphical capture application module 12 which then generates the desired display.

Display All Symbol Instances and Associated Data for an MFIN Instance

Given the MFIN Instance, display all records of MFIN Symbol Instances table 100l for the given MFIN Instance. The display may include information from the MFIN Symbols table 100h.

Display Status of a Given Case

Workflow application module 14 selects the record from Case Status table 100f associated with the given case, and displays the relevant data.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

We claim:

1. A workflow management system comprising:
means to create a plurality of MFINs, each of said MFINs representing a flowchart of a process;
means to associate said MFINs with one or more events;
means to convert said MFINs associated with one or more events into one or more workflow-oriented database tables; and
means to execute instances of one or more of said MFINs upon the occurrence of one or more of said events by looking up an entry associated with the event in the work flow-oriented database table.

2. The workflow management system of claim 1 wherein said system is a web-based computer application.

3. The workflow management system of claim 1 wherein said system is utilized for judicial case management.

4. The workflow management system of claim 1 wherein said system is a web-based computer application utilized for judicial case management.

5. The workflow management system of claim 1 wherein said MFINs comprise one or more functional elements selected from start, end, task, action, decision, wait and tickler functional elements.

6. The workflow management system of claim 5 wherein said task functional element comprises a default assignee and a default duration, means for establishing an actual assignee and expected duration when said task functional element is about to be executed by one of said MFINs, means for notifying said actual assignee of task assignments from the MFINS and due dates for the tasks calculated from the expected duration, and means for indicating task completion when executing said task functional element for one of said MFINs.

7. The workflow management system of claim 5 wherein said action functional element invokes one or more automatic actions when said action functional element is executed by one of said MFINs.

8. The workflow management system of claim 6 wherein said automatic actions are selected from setting a case status action, setting a register of actions, controlling a tickler time and controlling a wait time.

9. The workflow management system of claim 5 wherein said decision functional element evaluates a Boolean expression comprising when said decision functional element is executed by one of said MFINs, said decision functional element providing a different subsequent execution path depending if said Boolean expression is evaluated as true or false.

10. The workflow management system of claim 5 wherein said wait functional element comprises a wait interval and execution of one of said MFINs is suspended for a specific duration based on said wait interval when said wait functional element is executed by said MFIN.

11. The workflow management system of claim 5 wherein said tickler functional element comprises a tickler interval and means for commencing and resetting interval timings when said tickler functional elements are executed by one of said MFINs.

12. The workflow management system of claim 10 further comprising:
means for users to subscribe to one or more of said tickler functional elements, and means for subscribed users to be notified when the tickler interval of said one or more tickler functional elements have expired prior to being reset during the execution of the MFIN.

13. The workflow management system of claim 1 wherein said means to create a plurality of MFINs comprises a graphical capture application.

14. The workflow management system of claim 1 wherein said MFINs are associated with a predetermined workflow type.

15. The workflow management system of claim 14 wherein said workflow type is a case type.

16. The workflow management system of claim 1 wherein said MFINs are associated with a predetermined hierarchical level.

17. The workflow management system of claim 1 wherein said MFINs can be saved on a computer storage medium.

18. The workflow management system of claim 17 further comprising:
means for retrieval of said stored MFINs and means for modification of said retrieved MFINs, said modified MFINs including a date of when the modified MFINs become effective.

19. The workflow management system of claim 1 further comprising:
means for validating said MFINs for structural correctness.

20. The workflow management system of claim 1 wherein the selection of said one or more MFINs to execute is based on a workflow type of the occurring event.

21. The workflow management system of claim 1 wherein the selection of said or more MFINs to execute is based on a hierarchical level of the occurring event.

22. The workflow management system of claim 1 wherein the selection of said one or more MFINs to execute is based on a date of the occurring event.

23. A method for workflow management comprising the steps of:
creating a plurality of MFINs, said MFIN representing a flowchart of a process;
associating said MFINs with one or more events;
publishing said MFINs associated with one or more events into one or more workflow-oriented database tables; and
executing instances of one or more of said MFINs upon the occurrence of one or more of said events by looking up an entry associated with the event in the work flow-oriented database table.

24. The method of workflow management of claim 23 wherein said MFINs comprise one or more functional elements selected from start, end, task, action, decision, wait and tickler functional elements.

25. The method of workflow management of claim 24 wherein said task functional element comprises a default assignee and a default duration, and said method further comprising the steps of establishing an actual assignee and expected duration when said task functional element is about to be executed by one of said MFINs, notifying said actual assignee of task assignments from the MFINS and due dates for the tasks calculated from the expected duration and indicating task completion when executing said task functional element for one of said MFINs.

26. The method of workflow management of claim 24 wherein said action functional element invokes one or more automatic actions when said action functional element is executed by one of said MFINs.

27. The method of workflow management of claim 25 wherein said automatic actions are selected from setting a case status action, setting a register of actions, controlling a tickler time and controlling a wait time.

28. The method of workflow management of claim 24 wherein said decision functional element evaluates a Boolean expression comprising when said decision functional element is executed by one of said MFINs, said decision functional element providing a different subsequent execution path depending if said Boolean expression is evaluated as true or false.

29. The method of workflow management of claim 24 wherein said wait functional element comprises a wait interval and execution is of one of said MFINs is suspended for a specific duration based on said wait interval when said wait functional element is executed by said MFIN.

30. The method of workflow management of claim 24 wherein said tickler functional element comprises a tickler interval and further comprising the steps of commencing and resetting interval timings when said tickler functional elements are executed by the MFIN.

31. The method of workflow management of claim 32 further comprising the steps of, a user subscribing to one or more of said tickler functional elements, and notifying said subscribed user when the tickler interval of said one or more tickler functional elements have expired prior to being reset during the execution of the MFIN.

32. The method of workflow management of claim 23 wherein said plurality of MFINs are created with a graphical capture application.

33. The method of workflow management of claim 23 wherein said MFINs are associated with a predetermined workflow type.

34. The method of workflow management of claim 33 wherein said workflow type is a judicial case type.

35. The method of workflow management of claim 23 wherein said MFINs are associated with a predetermined hierarchical level.

36. The method of workflow management of claim 23 further comprising the step of:
storing said MFINs on a computer storage medium.

37. The method of workflow management of claim 36 further comprising the step of:
retrieving said stored MFINs; and
modifying said retrieved MFINs, the modified MFIN including a date of when the modified MFINs become effective.

38. The method of workflow management of claim 23 further comprising the step of:
validating said MFINs for structural correctness.

39. The method of workflow management of claim 23 wherein the selection of said one or more MFINs to execute is based on a workflow type of the occurring event.

40. The method of workflow management of claim 23 wherein the selection of said one or more MFINs to execute is based on a hierarchical level of the occurring event.

41. The method of workflow management of claim 23 wherein the selection of said one or more MFINs to execute is based on a date of the occurring event.
